(19) United States
(12) Patent Application Publication
(10) Pub. No.: US 2007/0282229 A1
(43) Pub. Date: Dec. 6, 2007

(54) Footbath Basin With Pressure Massage Function

(75) Inventors: Jian Yuan, Shenzhen (CN); Jiaxi Yuan, Shenzhen (CN)

Correspondence Address: ERIC CHAN, 42 PIN OAKS DRIVE, PHOENIXVILLE, PA, 19460, US

(73) Assignee: SHENZHEN JINGRUI INDUSTRY CO., LTD., Shenzhen, Guangdong (CN)

(21) Appl. No.: 11/573,644

(22) PCT Filed: Sep. 28, 2004
(86) PCT No.: PCT/CN04/01105

§ 371 Date: Feb. 13, 2007

(30) Foreign Application Priority Data
Aug. 13, 2004 (CN) 200410051131.9

(51) Int. Cl. A61H 1/00

(52) U.S. Cl. 601/55; 4/622

(57) ABSTRACT

The present invention relates to a footbath basin with pressure massage function, which comprising a body of footbath basin (11) and an air massage device (14) which comprises a plentiful of independent airbags. In the body of footbath basin (11), a pump (12), an input, and an air guide control device (13) are connected with the outputs of the pump of the body of footbath basin (11), the air guide control device (13) has a plentiful of outputs, at least two of which are connected with the input/output of the varied airbags of the air massage device (14) through an air tubes (17) respectively. The footbath basin with pressure massage function of the present invention may be cooperated with foot health care, and massage the other parts of the whole body simultaneously, enhance the whole blood circulation, make more effective health, and save time simultaneously.

### BACKGROUND OF THE INVENTION

The present invention relates to a footbath basin, more particularly, relates to a footbath basin with pressure massage function.

Nowadays, foot health care is a fashion. The apparatus for foot health carer in the prior art are integrated with massager, electrical heater and footbath basin, etc. However, these apparatus for foot health carer can massage feet only, other parts of the body can not be massaged. While people are enjoying foot massage with the footbath basin, it normally cost lots of time, and further, simplex function of foot health care for these apparatus is time inefficient.

### BRIEF SUMMARY OF THE INVENTION

The object of the present invention is to provide a footbath basin with pressure massage function, it may massage foot and other parts of the body simultaneously.

The technical solution for the present invention is to provide a footbath basin with air pressure massage function, which comprising a body of footbath basin and a plentiful of air pressure massagers with independent airbags, wherein a pump is installed in the footbath basin, and further comprises a air guide control device with its input port connected with the output of the pump of the footbath basin, the air guide control device has a plentiful of outputs, at least two of the outputs are connected with the inputs/outputs of varied airbags of the air massage device through air tubes respectively.

Advantageously, the air guide control device having an input connected with the pump, a plentiful of outputs connected with the a plentiful of airbags, and an air guide unit driven by a step motor with the rotation speed between 0 and 100 r/minute. The air guide unit is provided with a directing slots, thus when driven by step motor, the inputs are connected with the outputs via the directing slots on the air guide unit. The air guide unit further comprises air holes. When the air holes and the outputs are connected, airbags may be deflated, alternatively, the air guide control device comprises an input connected with the pump, a plentiful of outputs connected with the plentiful of airbags, and an electric-magnetic air valve.

Advantageously, the air guide control device comprises 4, 6 or 8 outputs.

Advantageously, the outputs of the air guide control device are set on the surface, side walls or top cover of the footbath basin.

Advantageously, a slide fastener or a nylon agraffe is provided on the air pressure massage device to wrap the body parts to be massaged.

Advantageously, when the air pressure device wrapping the body parts to be massaged, only one or one pair of the a plentiful of airbags are inflated, while other airbags deflates simultaneously, thus to massage the body parts one by one.

Advantageously, the massage modes of the footbath basin is selected from the group consisting of water pressure, vibrating and bubbles.

Advantageously, the air pressure massage device further comprises a plentiful of airbags for wrapping one or more body parts of thigh, calf, arm neck or waist.

Advantageously, a plentiful of pocket for placing vibrating massager are provided on the inner side of the air pressure massage device, and alternatively, the air pressure massage device are installed with vibrating device in the airbags.

Advantageously, the outside of the air pressure massage device are installed with an arc board.

Advantageously, the air guide control device is further connected to the footbath basin via a regurgitant tube, and through which the compressed air from the airbags is driven to the footbath basin.

Advantageously, the air pressure device is further installed with a heating device.

Advantageously, the air pressure device is further installed with a conductive electrode.

Advantageously, an air pressure adjusting device is connected between the air guide control device and pump, or between the air guide control device and airbags.

The footbath basin with pressure massage function of the present invention, may be cooperated with foot health care, and massage the other parts of the whole body simultaneously, enhance the whole blood circulation, make more effective health, and save time simultaneously.

### BRIEF DESCRIPTION OF THE DRAWINGS

Various aspects of the present invention will be discussed with reference to the drawings and embodiments.

FIG. 1 is the structure diagram of the footbath basin with air pressure massage function, in accordance with the present invention.

FIG. 2 is the structure diagram of another embodiment of the footbath basin with air pressure massage function, in accordance with the present invention.

FIG. 3 is part of the structure diagram of the air pressure massage device in FIG. 1, in accordance with the present invention.

FIG. 4 is part of the structure diagram of the air guide control device in FIG. 1, in accordance with the present invention.

### DETAILED DESCRIPTION OF THE INVENTION

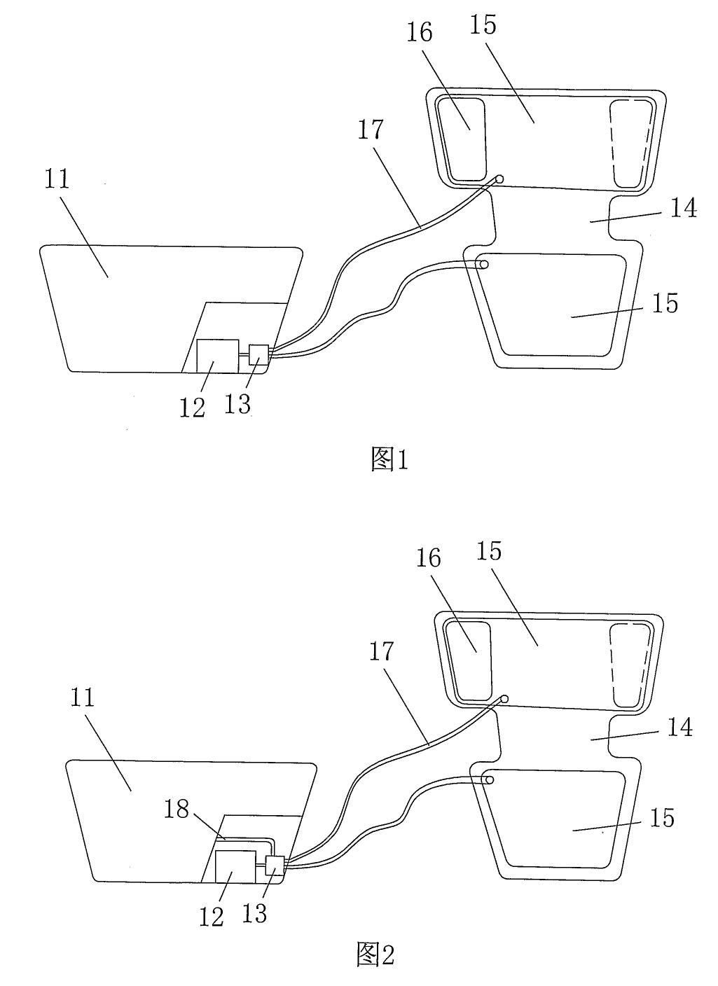

As shown in FIG. 1, the footbath basin with air pressure massage function comprises a body of footbath basin 11 and an air pressure massage device 14, wherein the body of footbath basin 11 may provide foot massage modes of water pressure, vibrating or bubbles. A pump 12 is provided in the body of footbath basin 11, the output of pump 12 is connected to an air guide control device 13, and the air guide control device 13 is connected with an air pressure massage device 14 (only part of it is shown in the figure) via a tube 17.

The air pressure device 14 may wrap around part of the body to be massaged by a nylon agraffe (magic sticker), and further comprises a plentiful of airbags 15 (only 2 of them is shown in the figure). Certainly, the air pressure device 14 may wrap around part of the body to be massaged by other connection, for example, slide fastener, buttons etc. The air pressure massage device 14 having airbags may wrap one or more of thigh, calf, arm, waist or neck. Each of the airbags 15 comprises an input/output, the input/output is connected to an air guide control device 13 via an air guide tubes to inflate or deflate the airbags. The inflation and deflation of airbags are controlled by the air guide control device 13 (the process will be described in detailed in FIG. 4).

Leg massage will be provided as an embodiment to describe the massage process. Firstly, the air guide control device 13 inflates the airbags wrapping the calf, when airbags are inflated, they oppresses the calf. Then, the air guide control device 13 inflates other bags that wrapping thigh, these airbags then will inflate and oppress thigh, thus to help blood flows back to heart, to achieve the effect of health care. This action is called as “milking a cow” movement. Certainly, more airbags may be employed, that is, more airbags are employed around calf and thigh, and to inflate the airbags orderly, thus to implement the movement of “milking a cow” in detail. Massaging other body parts is similar to the above-described process. While inflating one of the airbags, the air guide control device 13 deflates another airbag to inflate the deflated airbag subsequently, and further to implement the repetition of inflation and deflation.

An air pressure control device may also be provided between the air guide control device 13 and pump 12. The pressure inflated into airbags may be adjusted by the air pressure control device. The air pressure control device may also be installed between the air guide control device 13 and airbags, thus to adjust air inflated into each airbag respectively.

As shown in FIG. 2, in another embodiment of the present invention, an air deflation hole is also provided on the air guide control device 13, and is connected into the footbath basin via a regurgitant tube. When the air guide control device 13 deflates one of the airbags, compressed air flows back into the water in the footbath basin via tube 17, air guide control device 13 and regurgitant tube 18, thus to generate bubbles or water flow pressure to massage foot with bubbles.

A valve may be installed on the regurgitant tube 18, to ensure air flows out only from regurgitant tube 18, while water cannot flow into regurgitant tube 18. Certainly, the position of air guide control device 13 may be changed to avoid water in the body of footbath basin 11 flowing back into the air guide control device 13.

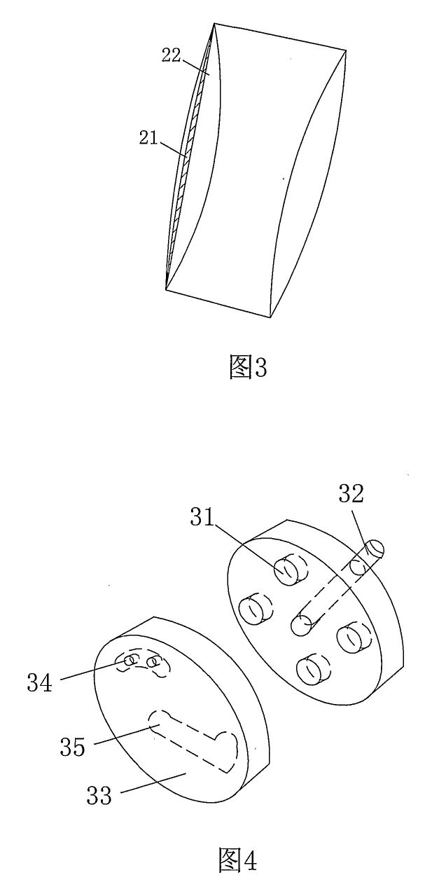

As shown in FIG. 3, is the structure diagram of part of the air pressure device 14. The air pressure massage device 14 in the present embodiment comprises multi-layer structure, wherein the most inner layer is airbag 22, the most outer layer is wrapper. An arc board 22 may also be installed between wrapper and airbag 22, thus the airbags only compress the wrapped part of the body without inflating outwards, thus better effect is achieved. The Nylon agraffe 16 is provided on the wrapper. And the wrapper may be made of fibre, or polymer or other materials.

In another embodiment of the present invention, double layer wrappers may be installed, that is, the most inner layer is also a wrapper. A pocket for placing vibrating massager may also be provided on the inner side of the wrapper. Vibrating massager may also be fixed on the inside of the airbags directly. Further, a heater such as electrical thermo wire etc may also be installed on the inner side of the wrapper, thus to perform heat cure while massaging. Conductive electrode may also be fixed on the inner layer of the wrapper, thus to excite the skin on the part of the body being massaged, to perform skin care movements.

As shown in FIG. 4, the air guide control device 14 comprises a air guide unit 33 and a ventilating piece. The ventilating piece is fixed on the air guide control device 14, and having an input 32 that connected with the output of pump 12, a plentiful of outputs 31 are connected with the inputs/outputs of the a plentiful of airbags. One end of the input 32 of air guide control device 14 is on the side of the ventilating piece, which is connected to the centre along the direction of the radius of the ventilating piece, and further passes through the centre. The outputs 31 pass through the ventilating piece along the axe of the ventilating piece. Outputs 31 may be set as a plentiful of pairs according to the number of the airbags, for example, 2, 4, 6 or 8, and are further placed on the same circle of the ventilating piece. The outputs 31 are set as 4 in the present embodiment.

The air guide unit 33 is buckled together with ventilating piece, it is further driven by a step motor with rotation speed between 0 and 100 r/minute. An air guide slot 35 is provided on the air guide unit 33, one end of the air guide slot 35 is on the centre of the air guide unit 33, and further connected to the corresponding position of the outputs 31 on ventilating piece along the radius direction.

When ventilating piece and air guide unit 33 are buckled together, the centre end of the input 32 on the ventilating piece is always connected with the centre end of the air guide slot 35, while the other end of the air guide unit 33 is connected with one of the outputs 31. When driven by the step motor, the air guide unit 33 rotates around the centre, thus the input 32 is connected with each output 31 via the air guide slot 35 on the air guide unit 33 orderly, therefore, to inflate different airbags.

The position corresponding to the output 31 on air guide unit 33 is fixed with hole 34, when hole 34 is connected to output 34, airbags may be deflated. When air guide unit 33 rotates, hole 34 may deflate each airbag.

1. A footbath basin with air pressure massage function, comprising a body of footbath basin and a plentiful of air pressure massage device with independent airbags, wherein an pump is installed in said footbath basin, and further comprises an input port and a air guide control device connected with the outputs of the pump of said footbath basin, said air guide control device has a plentiful of outputs, at least two of which are connected with the inputs/outputs of varied airbags of the air pressure massage device through a plentiful of air tubes respectively.

2. The footbath basin with air pressure massage function as in claim 1, wherein said air guide control device comprises an input connected with said pump, a plentiful of outputs connected with said plentiful of airbags, and an air guide unit driven by a step motor with rotation speed between 0 and 100 r/minute; said air guide unit is provided with a directing slots that when the air guide unit is driven by the step motor, said input is connected with the outputs via the directing slots on said air guide unit; said air guide unit further comprises an air holes, and when said air holes and said outputs connected, the airbags then be deflated.

3. The footbath basin with air pressure massage function as in claim 1, wherein said fluidic control device further comprises an input connected with said pump, a plentiful of outputs connected with said plurality of airbags, and an electric-magnetic air valve.

4. The footbath basin with air pressure massage function as in claims 2 or 3, wherein said air guide control device comprises 4, 6 or 8 outputs.

5. The footbath basin with air pressure massage function as in claims 2 or 3, wherein the outputs of said air guide control device are set on the surface, side walls or top cover of the footbath basin.

6. The footbath basin with air pressure massage function as in claim 1, wherein a slide fastener or a nylon agraffe is provided on said air pressure massage device to wrap the body parts to be massaged.

7. The footbath basin with air pressure massage function as in claim 6, wherein when air pressure massage device wrapping the body parts to be massaged, only one or one pair of said plentiful of airbags are inflated, and other airbags are deflated simultaneously, thus to massage the body parts one by one.

8. The footbath basin with air pressure massage function as in claim 6, wherein the massage mode of said footbath basin provides is selected from the group consisting of water pressure, vibrating and bubbles.

9. The footbath basin with air pressure massage function as in claim 6, wherein said air pressure massage device further comprises airbags that wrapping one or more body parts of thigh, calf, arm neck or waist.

10. The footbath basin with air pressure massage function as in claim 6, wherein a plentiful of pocket for placing vibrating massager are provided on the inside of said air pressure massage device; or the air pressure massage device are installed with vibrating device in the airbags.

11. The footbath basin with air pressure massage function as in claim 1, wherein an arc board is installed on the outside of said air pressure massage device.

12. The footbath basin with air pressure massage function as in claim 1, wherein the air guide control device is further connected to the footbath basin via a regurgitant tube, and through which the compressed air from the airbags is driven to the footbath basin.

12. The footbath basin with air pressure massage function as in claim 1, wherein a heating device is installed with said air pressure device.

14. The footbath basin with air pressure massage function as in claim 1, wherein a conductive electrode is installed with said air pressure device.

15. The footbath basin with air pressure massage function as in claim 1, wherein an air pressure adjusting device is connected between said air guide control device and pump, or between the air guide control device and airbags.
